(19) United States
(12) Patent Application Publication
(10) Pub. No.: US 2011/0173177 A1
(43) Pub. Date: Jul. 14, 2011

(54) SIGHTFUL CACHE: EFFICIENT INVALIDATION FOR SEARCH ENGINE CACHING

(76) Inventors: Flavio JUNQUEIRA, Barcelona (ES); Hugo Zaragoza, Barcelona (ES)

(21) Appl. No.: 12/685,345

(22) Filed: Jan. 11, 2010

(51) Int. Cl. G06F 17/30; G06F 12/00; G06F 12/08

(52) U.S. Cl. 707/709; 711/141; 707/706; 711/E12.001; 711/E12.037; 707/E17.014; 707/E17.008

(57) ABSTRACT

Updated queries are maintained in a cache. A search engine receives a query from a user through a query entry field. The search engine determines search results corresponding to the user query. A new entry mapping the user query to the search results is generated in a cache of results. A web crawler retrieves a new batch of documents for a particular document collection. A search index associated with a search engine is updated to reflect new documents in the document collection. A search engine of queries receives documents from the new batch of documents as inputs. Based on the received documents, the search engine of queries determines which of the queries would have returned the documents as relevant in a search. These queries are determined to be stale and invalidated.

### FIELD OF THE INVENTION

The present invention relates to techniques for efficiently maintaining up-to-date queries in a cache.

### BACKGROUND

Internet search engines allow computer users to use their Internet browsers (e.g., Mozilla Firefox) to submit search query terms to those search engines by entering those query terms into a search field (also called a “search box”). After receiving query terms from a user, an Internet search engine determines a set of Internet-accessible resources that are pertinent to the query terms, and returns, to the user's browser, as a set of search results, a list of the resources most pertinent to the query terms, usually ranked by query term relevance.

Search engines rely upon document collections crawled from the World Wide Web (“Web”) to process user queries. As documents on the Web continuously change, it is necessary for a search engine to also continuously update its document collections by crawling frequently. Although crawling frequently is important for the relevance of search results, it negatively impacts one critical component of search engines: the cache of results.

In a search engine, a cache of results stores results requested previously by users. Accordingly, caching results may improve responsiveness to user queries by avoiding reprocessing queries that are requested multiple times. However, as documents within a document collection change, cached queries may become stale. A stale query is a query for which the cached results are different from the results that would be obtained if the search engine reprocessed the query. For example, as mentioned above, a search engine continuously updates its document collections by crawling frequently because documents on the Web continuously change. If the crawler retrieves a new document to add to the search engine's document collection, a cached query may improperly fail to include the document among its search results. Similarly, if an old document is replaced, some cached queries may improperly return the document as a search result while other cached queries improperly fail to include the document. Therefore, a cache of results needs to address the problem of stale queries in some way.

One method to address the problem is to assign a time to live (TTL) value for every query in the cache. Once a fixed period of time, determined by the TTL value, has elapsed, the query expires. The value for TTL may be based on the time between consecutive changes to the search index, which range between several minutes and several days. Given the period between the changes to the index, a TTL value in the same order of magnitude is typically selected. Essentially, this solution assumes that once the fixed time period has elapsed, the query has become stale. However, this method may invalidate several cache entries unnecessarily because a query can become stale before it expires, or it may expire but not be stale. In the first case, the cache will return incorrect results, and in the second it will waste resources by evicting the query and causing misses and refreshes.

Moreover, as periods between updates to the index become shorter, the TTL invalidation technique becomes less efficient. In the extreme case in which the index is updated in real-time, caching becomes unrealistic as expired queries would need to be invalidated within very short periods of time. Therefore, some other more efficient and more accurate way is needed to invalidate stale queries.

The approaches described in this section are approaches that could be pursued, but not necessarily approaches that have been previously conceived or pursued. Therefore, unless otherwise indicated, it should not be assumed that any of the approaches described in this section qualify as prior art merely by virtue of their inclusion in this section.

### BRIEF DESCRIPTION OF THE DRAWINGS

The present invention is illustrated by way of example, and not by way of limitation, in the figures of the accompanying drawings and in which like reference numerals refer to similar elements and in which:

FIG. 1 shows a block diagram of various components which may be used to implement a sightful cache.

FIG. 2 shows a representation of a cache of results and an index of cached queries at a certain point in time.

FIGS. 3A and 3B show a flowchart illustrating a method for maintaining updated queries by efficiently invalidating stale queries from a cache.

FIG. 4 shows a flowchart illustrating a method for finding stale queries within a cache of results.

FIG. 5 shows a block diagram of a network architecture that could be used to implement a search engine embodying aspects of the present invention.

FIG. 6 shows a block diagram that illustrates a computer system upon which an embodiment of the invention may be implemented.

### DETAILED DESCRIPTION

In the following description, for the purposes of explanation, numerous specific details are set forth in order to provide a thorough understanding of the present invention. It will be apparent, however, that the present invention may be practiced without these specific details. In other instances, well-known structures and devices are shown in block diagram form in order to avoid unnecessarily obscuring the present invention.

### General Overview

According to techniques described herein, stale queries within a cache of results may be efficiently and accurately invalidated. A cache of results, as used herein, is a map from previously processed (e.g., by a search engine) user queries to their corresponding search results. In order to solve problems associated with stale cached queries, techniques described herein involve the design of a sightful cache. A sightful cache involves cache logic associated with the cache of results receiving feedback on changes to a document collection and acting on the feedback to find and invalidate stale queries from the cache of results.

A sightful cache may be contrasted with a blind cache. With a blind cache, the cache logic has no information about what has changed in a particular document collection. In order to invalidate queries in a blind cache, an unsophisticated, brute-force solution involves flushing all the content of the cache either periodically or upon explicit signaling of changes to the document collection (or the search index associated with the document collection). As a consequence of flushing the cache, much of the cache may be unnecessarily invalidated and later repopulated. Moreover, in a blind cache, where periods between updates to a search engine's document collection or search index become more frequent, the number of query refreshes and unnecessary query invalidation becomes larger. In contrast, a sightful cache can avoid unnecessary invalidation and repopulation of cache entries by invalidating only those queries which have become stale. Furthermore, a sightful cache drastically decreases the number of unnecessary query refreshes, which becomes more important as updates to the search engine's index become shorter. In particular, a sightful cache does not refresh queries in a cache for which there is no new content. Accordingly, a sightful cache provides a more efficient and accurate method for invalidating cache entries.

In order to implement the sightful cache, techniques are described herein relating to an inverted search engine, or “search engine of queries” (hereinafter referred to as “SEQ”). The SEQ receives, as input, feedback associated with a search engine's document collection. For example, as a web crawler is continuously crawling the Web, the crawler may retrieve a new batch of documents for a particular document collection. When the web crawler retrieves the new batch of documents, the search engine's document collection and search index are updated. When such an update is detected, one or more documents (“input documents”) from the new batch may be used as inputs to the SEQ. Outdated documents, such as those documents in the document collection that will be replaced by documents in the new batch, may also be used as inputs to the SEQ. The SEQ then uses these input documents to find and invalidate cached queries that have become stale. In other words, the SEQ identifies and invalidates all of the cached queries that would return the documents as relevant if a search engine executed a search of the query. In one embodiment, a search for queries is performed based on one or more terms contained by the input documents. Queries containing the one or more terms are identified and invalidated.

Another technique that may be implemented by a sightful cache involves indexing the queries contained in the cache of results. Indexing the queries may improve speed and performance when finding relevant queries associated with the input documents. According to one embodiment of the invention, an inverted index is used to search for queries relevant to the input documents. A simple implementation of an inverted index includes generating term indices that map one or more terms contained by the queries to one or more queries containing the terms. By using the term indices of the inverted index, a search for queries containing certain terms may be quickly performed. According to techniques described herein, alternative indices may also be used in order to aid in the search and invalidation of relevant queries.

### Search Engine of Queries

As indicated above, a sightful cache comprises cache logic to receive feedback on changes to a document collection. In one embodiment of the invention, this involves building a “search engine of queries” (SEQ). The SEQ takes documents as input and returns all the queries that, if submitted to a search engine, would return the document as relevant in search results. In this sense, the SEQ is a “reversed” or “inverted” search engine since it takes documents as inputs and ranks queries, instead of the other way around.

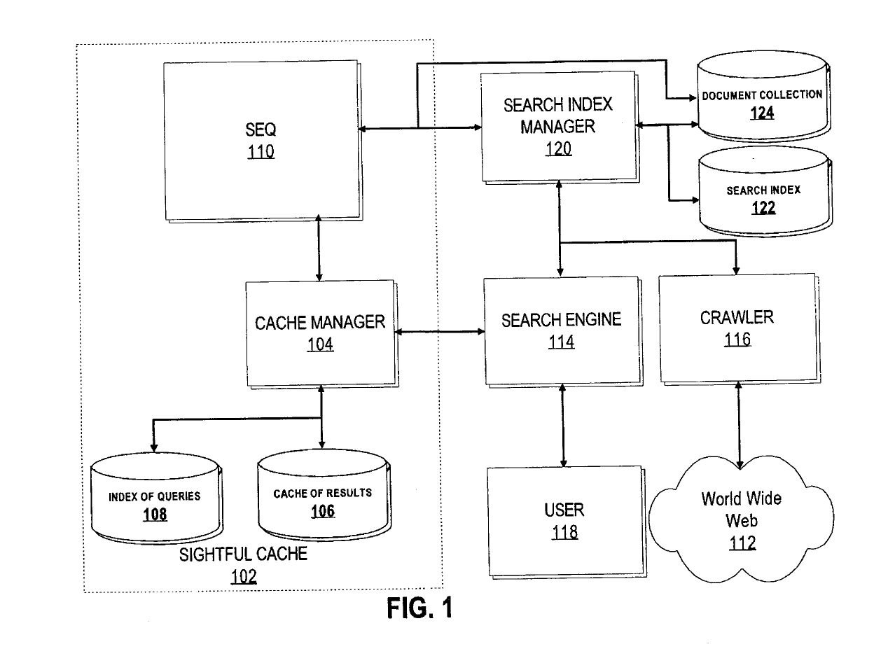

FIG. 1 illustrates one embodiment of the invention. Sightful cache 102 may be thought of as one component or separate components. Sightful cache 102 comprises SEQ 110, cache manager 104, index of queries 108, and cache of results 106, which are discussed in further detail below.

The example embodiment also comprises search engine component 114 and crawler component 116. Search engine component 114 takes user queries as input. For example, User 118 may use a standard browser to enter query terms into a search box. Search engine component 114 determines, based on document collection 124, search index 122, and/or cache of results 106, a set of documents that are pertinent to the query terms input by User 118. Search engine component 114 then returns, as a set of search results, a list of the documents most pertinent to the user query.

In order to avoid reprocessing user queries every time they are entered, a task that can be time-consuming especially when the document collection is large, a map from a user query to its corresponding search results are stored in cache of results 106 by cache manager 104. When a user query is received by search engine 114, search engine 114 communicates with cache manager 104 to determine whether cache of results 106 contains a matching user query that has not been invalidated. If cache manager 104 indicates that a corresponding user query is not stored in cache of results 106 or has been invalidated from cache of results 106, search engine 114 will process or reprocess the user query. Search engine component 114 executes a search to determine a list of best matching documents from document collection 124. Search engine component 114 searches search index 122 through search index manager 120 to find documents from document collection 124 meeting search criteria established by search engine 114. Search engine 114 generates search results in the form of a list of best matching documents and returns the search results to a user's browser. Cache manager 104 stores the user query and the corresponding search results in cache of results 106. When a repeat user query that has not been invalidated is received by search engine component 114, the search engine component 114 relies on the cache manager 104 to determine the relevant search results. Search engine component 114 sends the user query to cache manager 104 which identifies the query in cache of results 106 and returns the corresponding search results. By relying on cache manager 104 to return previously stored results, search engine component 114 improves responsiveness to user queries by avoiding the need to reprocess the user query and generate a new list of search results.

Crawler component 116 crawls servers through one or more networks to update document collection 124 and search index 122. For example, crawler component 116 may crawl Web servers through the Internet for interlinked hypertext documents on the World Wide Web 112. As the document collection on the Web is continuously changing, crawler component 116 will continuously be crawling. Crawler component 116 crawls the World Wide Web 112 according to standard spidering techniques. When crawler component 116 retrieves a new batch of documents from the Web, it provides the documents to search index manager 120, which indexes and stores the documents.

Search index manager 120 scans incoming documents retrieved by the crawler component 116. Search index manager 120 parses and stores information relating to the documents in search index 122 Search index manager 120 adds new documents to document collection 124 by generating new entries or replacing outdated documents. Accordingly, search index manager 120 improves searching by avoiding having to scan every document in the document collection when processing a user query. For example, instead of scanning all documents in document collection 124 to search for a document containing a certain query word or phrase, search index manager 120 may locate the word or phrase in search index 122 which points to all documents in document collection 124 containing the word or phrase.

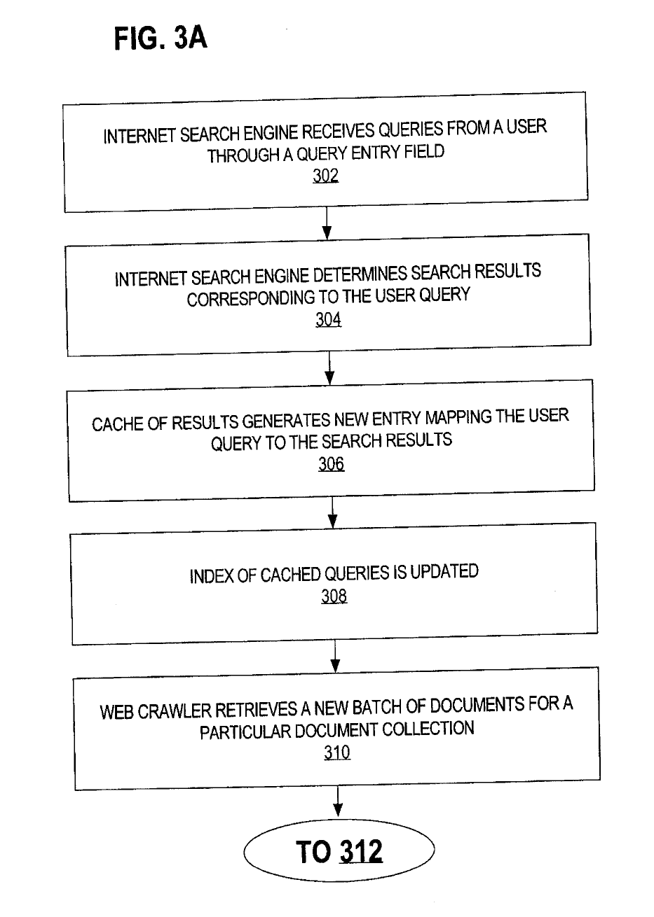

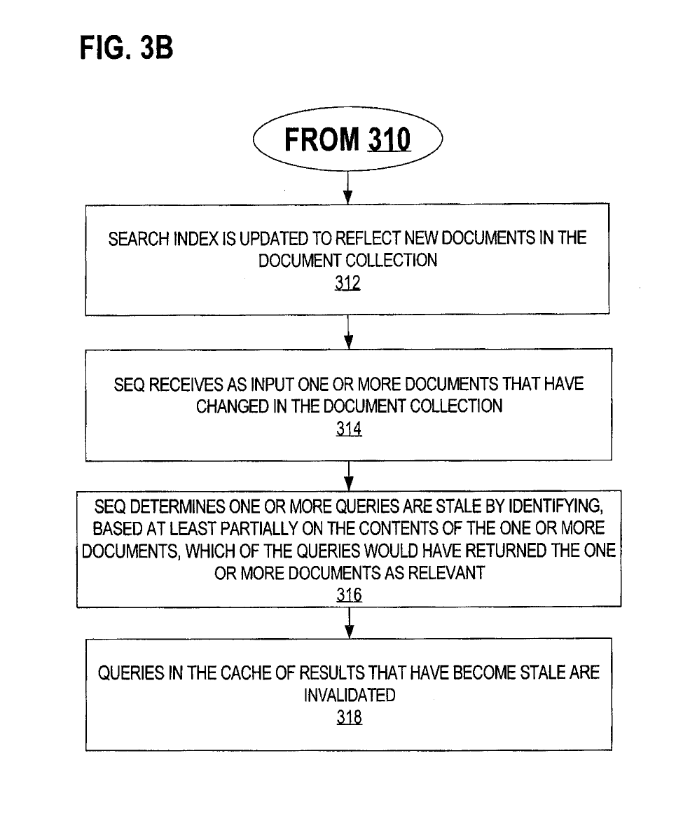

From time to time, search index manager 120 receives a new set of documents obtained by crawler component 116 through crawling the World Wide Web 112. Search index manager 120 may then signal SEQ 110 that a new document batch has been received. If search index 122 has not changed, none of the queries should have become stale and no documents need to be given to SEQ 110. If the search index 122 has changed, the new documents are sent to sightful cache 102, or specifically SEQ 110, as inputs. In FIG. 3, the input is shown as coming from search index manager 120 or document collection 124. However, this is only one embodiment; many alternative methods or channels may be used for obtaining the document as input. For example, the search index manager 120 may pass pointers or URIs associated with the new documents to SEQ 110. SEQ 110 may then use the URI to obtain the new document through Internet. Another embodiment entails SEQ 110 obtaining the document through a separate cache component which has stored the new documents.

In one embodiment, when SEQ 110 receives a new input document, SEQ 110 parses the contents of the document to determine which of the one of the cached queries would cause a search engine to return a set of results containing the document as relevant in a search for documents relevant to the query. Using the input documents, the SEQ 110 may establish search criteria in order to find the relevant queries. For instance, certain terms may be extracted from one or more of the input documents, and any query containing the terms may be returned. Such terms may be extracted through parsing and tokenization techniques. Furthermore, the terms may be weighted differently based on their relative importance. Common words, such as articles (e.g. “a”, “an”, “the”) or prepositions (e.g., “to”, “with”, “on”), may be ignored, or assigned little weight when extracting terms or executing a search for queries. In an alternative embodiment, search criteria are not limited to extracted terms. For example, a document-query similarity function may be used to compare the overall similarities of the query to a particular document. To illustrate, one similarity function may compare words and phrasing of a cached query to the input documents. The cached query is assigned a ranking depending on how similar the phrasing is to phrasing in the input documents, and how frequently words or phrases contained by the cached query appear in the input document. Queries that are ranked above a certain level are determined to be stale.

In one embodiment of the invention, which is discussed further below, SEQ 308 uses index of queries 108 in order to find the relevant queries. Cache manager 104 receives processed user queries and their corresponding search results from search engine component 114. Cache manager 104 stores the user queries and corresponding search results in cache of results 106. Cache manager 104 also indexes the queries which it stores in index of queries 108. Indexing queries may improve speed and performance when finding relevant queries. Index 110 may also be used to help establish search criteria. For instance, terms contained by the queries may be indexed and compared against the terms of the input documents. Only terms contained in the index may be extracted from an input document and used to invalidate relevant queries.

SEQ 110 identifies queries that match the search criteria and determines that these queries are stale. SEQ 110 sends information about which queries have become stale to cache manager 104. For example, in one embodiment SEQ 110 sends one or more invalidation messages to cache manager 104 which reference one or more queries that SEQ 110 has determined to be stale. Cache manager 104 then invalidates these queries from cache of results 106.

In one embodiment, when cache manager 104 invalidates a query, cache manager 104 deletes cache entries from cache of results 106 corresponding to the query. In one embodiment, invalidation involves deleting the entire cache entry corresponding to the query. Alternatively, cache manager 106 may delete only part of the cache entry corresponding to the user query. For example, cache manager 106 may delete search results corresponding to the query, but leave the query residing in cache of results 106. In one embodiment, when cache manager 106 receives an invalidation message, cache manager 106 simply marks the query as invalid. Thus, the query may remain in cache of results 106; however, if search engine 114 requests search results from cache manager 104 corresponding to the query, cache manager 104 returns with a message indicating the query is invalid. Search engine 114 then reprocesses the query to determine a new set of search results. When the new set of search results is obtained, the new results are stored in cache of results 106, and the query is no longer marked invalid. In another embodiment, invalidation may also entail updating the stale query in order to repair its stale state. For example, if SEQ 110 receives a new document and determines that a query should return the document as relevant, instead of deleting the cache entry, the entry corresponding to the query's search results may be updated to include the new document. To illustrate, if cached query Q1 is mapped to documents D1 and D2, and crawler component 116 retrieves new document D3, which SEQ 110 determines is relevant to Q1, then the cache entry is updated to map Q1 to documents D1, D2, and D3.

### Query Indexing and Searching

In one embodiment of the invention, the cached queries are indexed. Cached queries may be indexed according to a number of methods as indicated herein. In one embodiment, terms contained by the queries are mapped to the one or more queries containing the terms. Thus, terms contained by the input document to SEQ 110 may be compared against index of queries 108 to quickly find all queries containing the term.

When a new document, d, arrives for a given document collection (e.g., crawler component 116 retrieves document from the Web 112), the document is sent to SEQ 110. SEQ 110 invalidates queries from cache of results 106 according to an invalidation policy, I(d). The invalidation policy establishes criteria that SEQ 110 uses to identify and invalidate queries. For example, the invalidation policy's criteria may comprise rules on how to weight terms extracted from document d or how to rank queries. In one embodiment, all the queries containing one or more terms in the new document are invalidated according to the invalidation policy I(d). This may be implemented as follows: d is defined as a set of term indices indicating which terms are present in the document d, which is received as input to SEQ 110. Similarly, q is defined as the set of indices of terms in the cached query q residing in cache of results 106. This may be represented by the following equation:

I(d):={q|qεC,∩≠]

In one embodiment, the invalidation of all queries containing one or more terms in the new document is implemented with an inverted index of queries. As mentioned above, an inverted index of queries maps terms contained by the cached queries to the queries containing the terms. In one embodiment, the inverted index may be implemented as follows: set Sₜ represents a set of cached queries which contain term t. Set Sₜ is stored in index of queries 108. For example, if “pizza” has a term index of 14 and appears in queries 3 and 17, and “Barcelona” has a term index of 5, and appears only in query 17, the index may be represented as follows:

S₁₄ [symbol] {Q3,Q17}

S₅ [symbol] {Q17}

When a document arrives, for each term t in the document, all the queries in the corresponding set Sₜ are invalidated according to invalidation policy I(d). For example, the invalidation policy may be defined as:

$$I ( d ) := {⋃}_{d ∈} {S}_{t}$$

There are many standard techniques to efficiently encode and compress the inverted index, and compute the union shown in the above equation.

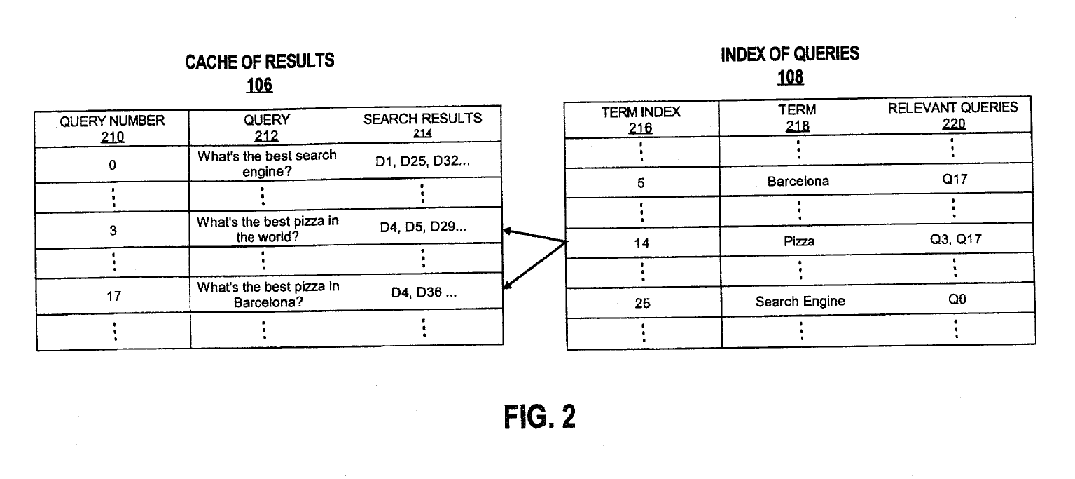

Continuing with the above example, FIG. 2 illustrates an example of what cache of results 106 and index of queries 108 might look like at a given point in time. A cache entry in cache of results 106 comprises an address or query number 210 which identifies a query 212 and the query's corresponding search results 214 Search results 214 comprises a list of documents previously obtained search engine 114 executing a search using the query. For example, for the query “What's the best pizza in the world?” the search results obtained by search engine 114 included documents D4, D5, and D29. Index of queries 108 is implemented as an inverted index. In one embodiment, index of queries 108 comprises term index 216 which identifies a term 218 and maps the term to relevant queries 220. In one embodiment, relevant queries are queries that contain the term. If crawler component 114 retrieves a new document or replaces an old document containing the term “pizza,” search index manager 120 adds or replaces the document to document collection 124 and sends the document to SEQ 110. SEQ 110 parses the document and extracts one or more terms from the document, including “pizza.” SEQ 110 sends term pizza to cache manager 104 which finds “pizza” at term index 14. Term index 14 indicates that “pizza” is contained by Q3, and Q17, which corresponds to the query number in cache of results 106. In one embodiment, cache manager 104 invalidates Q3 and Q17. In another embodiment, Q3 and Q17 are returned to SEQ 110 for further determination as to whether the query is stale. For example, SEQ may further use a document-similarity function to determine whether the query is stale, as described further below.

Instead of using the Boolean technique of matching a term extracted from a document to a term found in the term index of index of queries 108, other techniques may be used to invalidate queries. In one embodiment, queries may be ranked by some document-query similarity function in order to prioritize invalidations. To illustrate, the document-query similarity function may compare the overall similarities of the query to a particular document. In one embodiment, the similarity function compares words and phrasing of a cached query to the input documents. The cached query is assigned a ranking depending on how similar the phrasing is to phrasing in the input documents, and how frequently words or phrases contained by the cached query appear in the input document. Queries are invalidated in order of ranking. That is, queries ranked most similar to the document are invalidated first. This embodiment may be used in the case of cache refreshing via priority queues. Alternatively, all queries above a certain ranking are invalidated. In other embodiments, queries can be indexed according to standard techniques, such as meta-tag indexing, tree indexing, forward indexing, etc.

### Example Flow

FIG. 3 shows a flowchart illustrating a method for maintaining updated queries by invalidating stale queries from a cache. The method comprises an internet search engine receiving a query from a user through a query entry field (block 302). The internet search engine then determines search results corresponding to the user query (block 304). Next, a new entry in the cache of results is generated which maps the user query to the search results (block 306). By caching the query, the search engine may optimize responsiveness and speed by avoiding the reprocessing of repeat queries.

In one embodiment, an index of cached queries is updated (block 308). Queries may be indexed according to techniques described above. In one embodiment, the index of queries is updated when a new query is received or when an old query is reprocessed by a search engine.

Because the document collection on the Web is constantly changing, a web crawler is responsible for browsing the Web to keep up-to-date on any recent additions or changes. The web crawler retrieves a new batch of documents for a particular document collection (block 310). For example, this may be done through standard spidering techniques. Based on the new batch of documents, the search index is updated to reflect new documents in the document collection (block 312). For instance, the web crawler may generate copies of documents from sites visited on the web. The downloaded documents are then indexed to provide for faster searches. New documents may include new additions to the document collection or documents that replace outdated documents in the document collection.

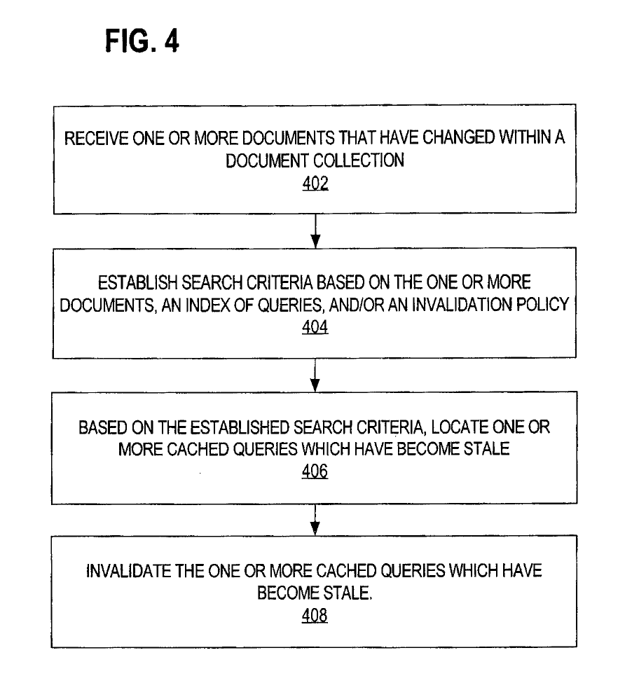

In one embodiment, a search engine of queries (“SEQ”) receives as input one or more documents that have changed in the document collection (block 314). In one embodiment, the SEQ receives one or more documents from the new batch of documents retrieved by a web crawler. The SEQ may also receive as inputs documents that have been or will be replaced by documents in the new batch of documents. The SEQ determines one or more queries are stale by identifying, based at least partially on the contents of the one or more documents, which of the queries would have returned the documents as relevant (block 316). The SEQ may also use the index of queries to help determine or identify which queries are stale. The step of block 316 may be accomplished according to techniques described in the previous sections or according to one or more steps shown in FIG. 4. The SEQ then returns these queries as stale, for example, by sending an invalidation message to the cache of results. The queries in the cache of results that have become stale are then invalidated (block 318). As mentioned above, invalidation of queries may entail deleting one or more entries related to the query from the cache, marking the queries as stale such as through metadata, or remapping the query to the correct set of relevant documents.

FIG. 4 shows a flowchart illustrating a method for identifying and invalidating stale queries from a cache. The method comprises receiving as input one or more documents that have changed within a document collection (block 402). As indicated above, one embodiment comprises receiving one or more documents from a batch of documents that are new to the document collection. The one or more documents may also comprise documents from the document collection that have been or will be replaced. Next, search criteria are established based on the one or more documents, an index of queries, and/or an invalidation policy (block 404). Search criteria may be established in accordance with the techniques described in the previous sections. Based on the established search criteria, one or more cached queries which have become stale are located (block 406). The one or more cached queries which have become stale are then invalidated (block 408). Again, these techniques may be implemented according to techniques described above.

### Hardware Overview

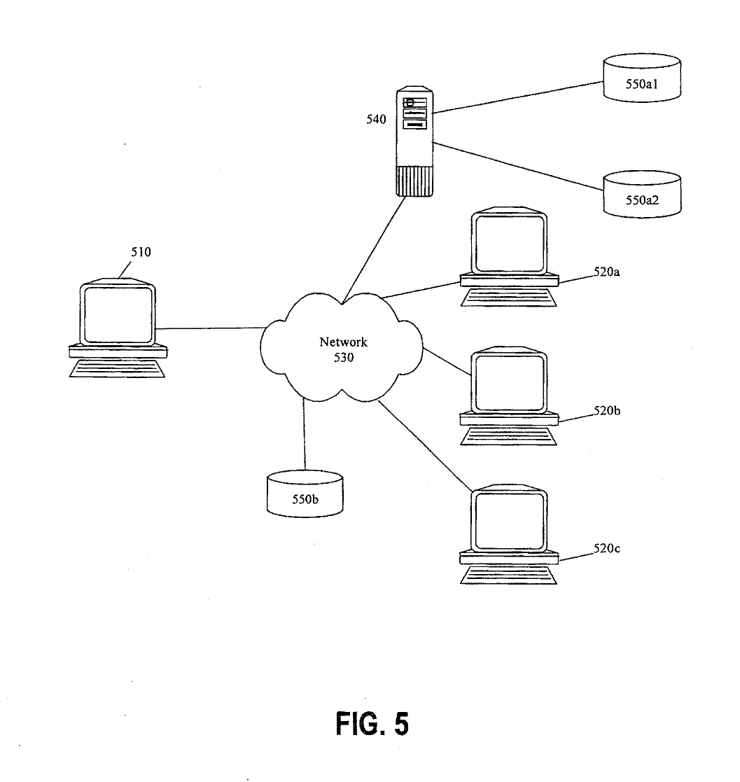

FIG. 5 illustrates the components of a possible network architecture for implementing a search system embodying aspects of the present invention. The system 500 can include one or more master terminals 510, one or more user terminals 520a-c, and one or more servers 540 connected through a network 530. One or more of the terminals 510, 520a-c may be personal computers, computer workstations, PDAs, mobile phones or any other type of microprocessor-based device that can execute web-client software. The one or more servers 540 can be used for storing search engine software, including software related to a sightful cache. The one or more servers 540 can further access one or more databases (e.g., databases 550a1, 550a2, and 550b). The databases may either be accessed directly or over the network 530.

The network 530 may be a local area network (LAN), wide area network (WAN), remote access network, an intranet, or the Internet, for example. Network links for the network 530 may include telephone lines, DSL, cable networks, T1 or T3 lines, wireless network connections, or any other arrangement that implements the transmission and reception of network signals. However, while FIG. 5 shows the terminals 510, 520a-c, servers 540, and databases 550a1, a2, b, connected through a network 530, the terminals 510, 520, servers 540, and databases 550b may alternatively be connected through other means, including directly hardwired as in the case of database 550b or wirelessly connected. In addition, the terminals 510, 520a-c, servers 540, and databases 550a-b may be connected to other network devices not shown, such as wired or wireless routers.

It will be readily apparent to one skilled in the art that the components described in reference to FIGS. 1 and 2 or the methods in FIGS. 3 and 4 might be contained on one terminal 510, 520a-c, server 540, or database 550a-b or may be distributed over multiple terminals 510, 520a-c, servers 540, and databases 550a-b spread out across the system.

According to one embodiment, the techniques described herein are implemented by one or more special-purpose computing devices. The special-purpose computing devices may be hard-wired to perform the techniques, or may include digital electronic devices such as one or more application-specific integrated circuits (ASICs) or field programmable gate arrays (FPGAs) that are persistently programmed to perform the techniques, or may include one or more general purpose hardware processors programmed to perform the techniques pursuant to program instructions in firmware, memory, other storage, or a combination. Such special-purpose computing devices may also combine custom hard-wired logic, ASICs, or FPGAs with custom programming to accomplish the techniques. The special-purpose computing devices may be desktop computer systems, portable computer systems, handheld devices, networking devices or any other device that incorporates hard-wired and/or program logic to implement the techniques.

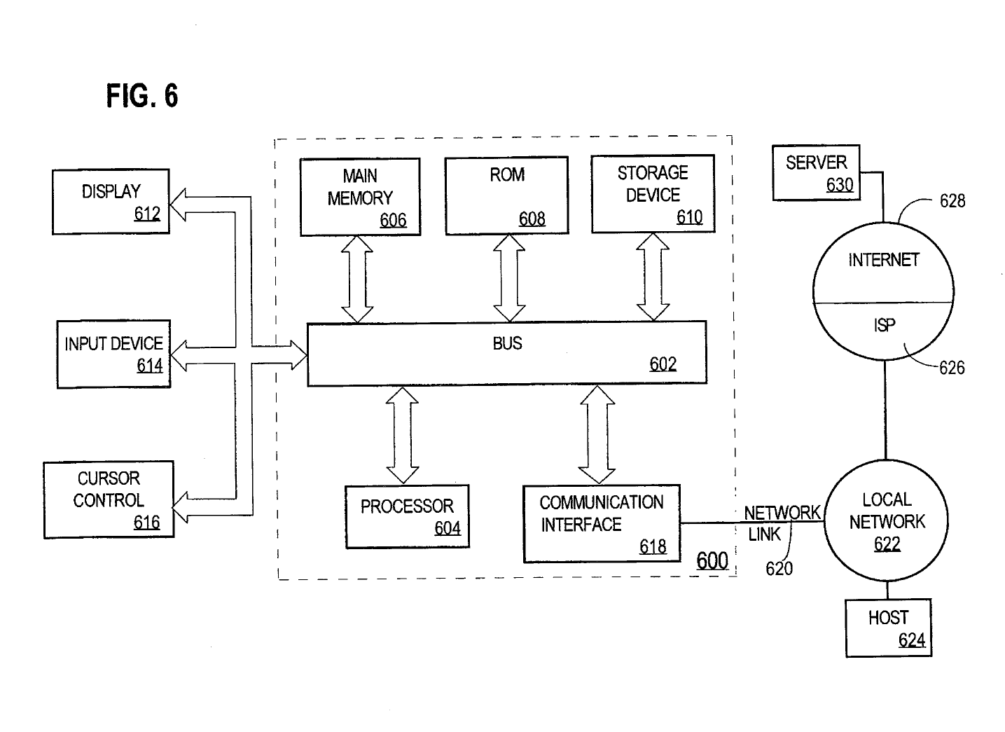

For example, FIG. 6 is a block diagram that illustrates a computer system 600 upon which an embodiment of the invention may be implemented including the components shown in FIGS. 1 and 2 or the methods shown in FIGS. 3 and 4. Computer system 600 includes a bus 602 or other communication mechanism for communicating information, and a hardware processor 604 coupled with bus 602 for processing information. Hardware processor 604 may be, for example, a general purpose microprocessor.

Computer system 600 also includes a main memory 606, such as a random access memory (RAM) or other dynamic storage device, coupled to bus 602 for storing information and instructions to be executed by processor 604. Main memory 606 also may be used for storing temporary variables or other intermediate information during execution of instructions to be executed by processor 604. Such instructions, when stored in storage media accessible to processor 604, render computer system 600 into a special-purpose machine that is customized to perform the operations specified in the instructions.

Computer system 600 further includes a read only memory (ROM) 608 or other static storage device coupled to bus 602 for storing static information and instructions for processor 604. A storage device 610, such as a magnetic disk or optical disk, is provided and coupled to bus 602 for storing information and instructions.

Computer system 600 may be coupled via bus 602 to a display 612, such as a cathode ray tube (CRT), for displaying information to a computer user. An input device 614, including alphanumeric and other keys, is coupled to bus 602 for communicating information and command selections to processor 604. Another type of user input device is cursor control 616, such as a mouse, a trackball, or cursor direction keys for communicating direction information and command selections to processor 604 and for controlling cursor movement on display 612. This input device typically has two degrees of freedom in two axes, a first axis (e.g., x) and a second axis (e.g., y), that allows the device to specify positions in a plane.

Computer system 600 may implement the techniques described herein using customized hard-wired logic, one or more ASICs or FPGAs, firmware and/or program logic which in combination with the computer system causes or programs computer system 600 to be a special-purpose machine. According to one embodiment, the techniques herein are performed by computer system 600 in response to processor 604 executing one or more sequences of one or more instructions contained in main memory 606. Such instructions may be read into main memory 606 from another storage medium, such as storage device 610. Execution of the sequences of instructions contained in main memory 606 causes processor 604 to perform the process steps described herein. In alternative embodiments, hard-wired circuitry may be used in place of or in combination with software instructions.

The term “storage media” as used herein refers to any media that store data and/or instructions that cause a machine to operate in a specific fashion. Such storage media may comprise non-volatile media and/or volatile media. Non-volatile media includes, for example, optical or magnetic disks, such as storage device 610. Volatile media includes dynamic memory, such as main memory 606. Common forms of storage media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM, NVRAM, any other memory chip or cartridge.

Storage media is distinct from but may be used in conjunction with transmission media. Transmission media participates in transferring information between storage media. For example, transmission media includes coaxial cables, copper wire and fiber optics, including the wires that comprise bus 602. Transmission media can also take the form of acoustic or light waves, such as those generated during radio-wave and infra-red data communications.

Various forms of media may be involved in carrying one or more sequences of one or more instructions to processor 604 for execution. For example, the instructions may initially be carried on a magnetic disk or solid state drive of a remote computer. The remote computer can load the instructions into its dynamic memory and send the instructions over a telephone line using a modem. A modem local to computer system 600 can receive the data on the telephone line and use an infra-red transmitter to convert the data to an infra-red signal. An infra-red detector can receive the data carried in the infra-red signal and appropriate circuitry can place the data on bus 602. Bus 602 carries the data to main memory 606, from which processor 604 retrieves and executes the instructions. The instructions received by main memory 606 may optionally be stored on storage device 610 either before or after execution by processor 604.

Computer system 600 also includes a communication interface 618 coupled to bus 602. Communication interface 618 provides a two-way data communication coupling to a network link 620 that is connected to a local network 622. For example, communication interface 618 may be an integrated services digital network (ISDN) card, cable modem, satellite modem, or a modem to provide a data communication connection to a corresponding type of telephone line. As another example, communication interface 618 may be a local area network (LAN) card to provide a data communication connection to a compatible LAN. Wireless links may also be implemented. In any such implementation, communication interface 618 sends and receives electrical, electromagnetic or optical signals that carry digital data streams representing various types of information.

Network link 620 typically provides data communication through one or more networks to other data devices. For example, network link 620 may provide a connection through local network 622 to a host computer 624 or to data equipment operated by an Internet Service Provider (ISP) 626. ISP 626 in turn provides data communication services through the world wide packet data communication network now commonly referred to as the “Internet” 628. Local network 622 and Internet 628 both use electrical, electromagnetic or optical signals that carry digital data streams. The signals through the various networks and the signals on network link 620 and through communication interface 618, which carry the digital data to and from computer system 600, are example forms of transmission media.

Computer system 600 can send messages and receive data, including program code, through the network(s), network link 620 and communication interface 618. In the Internet example, a server 630 might transmit a requested code for an application program through Internet 628, ISP 626, local network 622 and communication interface 618.

The received code may be executed by processor 604 as it is received, and/or stored in storage device 610, or other non-volatile storage for later execution.

### Extensions and Alternatives

In this description certain process steps are set forth in a particular order, and alphabetic and alphanumeric labels may be used to identify certain steps. Unless specifically stated in the description, embodiments of the invention are not necessarily limited to any particular order of carrying out such steps. In particular, the labels are used merely for convenient identification of steps, and are not intended to specify or require a particular order of carrying out such steps.

In the foregoing specification, embodiments of the invention have been described with reference to numerous specific details that may vary from implementation to implementation. Thus, the sole and exclusive indicator of what is the invention, and is intended by the applicants to be the invention, is the set of claims that issue from this application, in the specific form in which such claims issue, including any subsequent correction. Any definitions expressly set forth herein for terms contained in such claims shall govern the meaning of such terms as used in the claims. Hence, no limitation, element, property, feature, advantage or attribute that is not expressly recited in a claim should limit the scope of such claim in any way. The specification and drawings are, accordingly, to be regarded in an illustrative rather than a restrictive sense.

What is claimed is:

1. A method for maintaining updated queries in a cache, the method comprising:
receiving one or more documents from a set of documents that has changed within a particular document collection;
determining that one or more queries in a cache have become stale based on the one or more documents;
in response to determining that the one or more queries have become stale, invalidating the one or more queries in the cache;
wherein the method is performed by one or more special-purpose computing devices.

2. The method of claim 1, wherein the cache maps a user query previously entered into a search engine to one or more search results returned by the search engine.

3. The method of claim 1, wherein determining that one or more queries in the cache have become stale based on the one or more documents comprises determining which of the one or more queries contained in the cache would return a particular document of the one or more documents as relevant in a search.

4. The method of claim 1, wherein determining that the one or more queries in the cache have become stale based on the one or more documents comprises:
establishing one or more search criteria based on the one or more documents;
searching the cache for one or more queries that satisfy the one or more search criteria;
determining that any of the one or more queries that satisfy the one or more search criteria are stale.

5. The method of claim 1, wherein determining that the one or more queries in the cache have become stale based on the one or more documents comprises:
selecting one or more terms which are contained by a particular document of the one or more documents;
determining that all the queries of the one or more queries containing any of the one or more terms are stale.

6. The method of claim 5, wherein determining that all queries of the one or more queries containing any of the one or more terms are stale further comprises:
locating, in an inverted index, a particular term of the one or more terms;
determining a plurality of queries to which the particular term is mapped in the inverted index; and
determining that each query of the plurality of queries is stale.

7. The method of claim 1, further comprising indexing the one or more queries in an index of queries.

8. The method of claim 7, wherein determining that the one or more queries in the cache have become stale based on the one or more documents comprises:
establishing one or more search criteria based on the one or more documents;
searching the index of queries for one or more queries that satisfy the one or more search criteria;
determining that any of the one or more queries that satisfy the one or more search criteria are stale.

9. The method of claim 1, wherein invalidating the one or more queries in the cache comprises altering a list of search results stored in the cache that is associated with the one or more queries, wherein altering the list of search results comprises adding the one or more documents to the list of search results.

10. A computer readable storage medium comprising a sequence of instructions, which when executed by one or more processors, perform steps of:
receiving one or more documents from a set of documents that has changed within a particular document collection;
determining that one or more queries in a cache have become stale based on the one or more documents;
invalidating the one or more queries in the cache in response to determining that the one or more queries have become stale.

11. The computer readable storage medium of claim 10, wherein the cache maps a user query previously entered into a search engine to one or more search results returned by the search engine.

12. The computer readable storage medium of claim 10, wherein determining that one or more queries in the cache have become stale based on the one or more documents comprises determining which of the one or more queries contained in the cache would return a particular document of the one or more documents as relevant in a search.

13. The computer readable storage medium of claim 10, wherein determining that the one or more queries in the cache have become stale based on the one or more documents comprises:
establishing one or more search criteria based on the one or more documents;
searching the cache for one or more queries that satisfy the one or more search criteria;
determining that any of the one or more queries that satisfy the one or more search criteria are stale.

14. The computer readable storage medium of claim 10, wherein determining that the one or more queries in the cache have become stale based on the one or more documents comprises:
selecting one or more terms which are contained by a particular document of the one or more documents;
determining that all the queries of the one or more queries containing any of the one or more terms are stale.

15. The computer readable storage medium of claim 14, wherein determining that all queries of the one or more queries containing any of the one or more terms are stale further comprises:
locating, in an inverted index, a particular term of the one or more terms;
determining a plurality of queries to which the particular term is mapped in the inverted index; and
determining that each query of the plurality of queries is stale.

16. The computer readable storage medium of claim 10, further comprising indexing the one or more queries in an index of queries.

17. The computer readable storage medium of claim 16, wherein determining that the one or more queries in the cache have become stale based on the one or more documents comprises:
establishing one or more search criteria based on the one or more documents;
searching the index of queries for one or more queries that satisfy the one or more search criteria;
determining that any of the one or more queries that satisfy the one or more search criteria are stale.

18. The computer readable storage medium of claim 10, wherein invalidating the one or more queries in the cache comprises altering a list of search results stored in the cache that is associated with the one or more queries, wherein altering the list of search results comprises adding the one or more documents to the list of search results.

19. A computer apparatus for maintaining updated queries in a cache, the apparatus comprising:
a cache component that stores one or more queries and maps each of the one or more queries to one or more corresponding search results;
a document collection component that maintains a search index which may be used by a search engine to determine one or more search results corresponding to a user query;
a crawler component that retrieves one or more new documents for the document collection component by crawling one or more networks;
a search engine component that receives user queries and returns corresponding search results based on the cache component and the document collection component;
a search engine of queries component that receives one or more documents from the one or more new documents and determines that one or more queries in the cache component have become stale based on the one or more documents.
